(19) United States
(12) Patent Application Publication
(10) Pub. No.: US 2026/0073393 A1
(43) Pub. Date: Mar. 12, 2026

(54) SILENT PUSH NOTIFICATION TO AUTHENTICATE CLIENTS

(71) Applicant: Bank of America Corporation, Charlotte, NC (US)

(72) Inventors: David B. Lanning, Chester, VA (US); William Hodges, Mechanicsville, VA (US); Torrie J. Jones, Newark, DE (US); Youshika C. Scott, Charlotte, NC (US); Mark A. Zunino, Neward, DE (US); Amijo Bearley, Newark, DE (US); Robert Allee, Chambersburg, PA (US)

(21) Appl. No.: 18/882,934

(22) Filed: Sep. 12, 2024

(51) Int. Cl. G06Q 20/40

(52) U.S. Cl. CPC G06Q 20/4015

(57) ABSTRACT

Systems and methods for sending a silent push notification to a mobile device application (“MDA”) enabling a flagged transaction. The systems and methods may include receiving, by a computing processor, a request for a transaction. The systems and methods may include analyzing, by the computing processor, the transaction to determine a security level. The systems and methods may include generating, by a machine learning model (“MLM”) on the computing processor, a first security score for the transaction, the first security score based on the security level. The systems and methods may include flagging, by the computing processor, the transaction when the first security score is below a threshold security score. The systems and methods may include sending, by the computing processor via a server cloud, a silent push notification to a trusted user device. The silent push notification may include a notification payload with security data from the flagged transaction.

### FIELD OF TECHNOLOGY

Aspects of the disclosure relate to client authentication.

### BACKGROUND OF THE DISCLOSURE

Current client authentication methods used by companies provide clients with a range of options to prove their identity. Some of these authentication methods may be targeted to improperly gain access to client information and/or to complete unauthenticated transactions. Enriching existing authentication options with additional security signals invisible to a client's experience may prevent efforts to commit improper transactions.

Therefore, it would be desirable to enhance security and prevent bad acts, such as account takeover, identity theft, and elder abuse, by verifying a user's location during flagged transactions using silent push notifications.

It would be further desirable to provide systems and methods that enable a client to efficiently process a flagged transaction in a seamless manner using silent push notifications.

### SUMMARY OF THE DISCLOSURE

Systems and methods for utilizing silent push notifications to enable flagged transactions are provided.

When a transaction is initiated, the transaction may be flagged for security reasons. For each flagged transaction, a silent push notification may then be sent to a trusted user device.

A mobile device application (“MDA”) may then initiate location sharing to determine if the user is at a known or trusted location (e.g., an entity branch). Location data may be used to determine a user's location when a high-security transaction is initiated. It may be assumed that a user's phone location is a proxy to the user's actual location and their location should be resolved to a location related to the high-security transaction.

For the purposes of this application, the term “push notification” refers to unilaterally generated electronic messaging from a first entity to a second entity.

When a client begins to authenticate their identity a “silent” push notification may be sent to the client's mobile device on record that has the mobile entity application installed.

This silent push notification may not generate a visible notification message on the client's device but rather the client's device may gather and return device-related data (“device data”) for that mobile device.

Once retrieved, the device data may be fed into real-time authentication strategies to assess security and influence what is required for a client to complete the authentication process.

Additionally, the device data collected at the authentication event may be used as an input in fraud cases when a client disputes that he or she did not authenticate and complete a transaction with an entity.

The systems and methods may include the use of a notification that is invisible to the client to collect device data to use in client identification and authentication.

Using that data, the systems and methods may assess security level of authentication attempt, influence client authentication (add or reduce friction), protect client against fraud attempts, and improve fraud claim decisioning. Additional friction for client authentication may include, for example, more authentication questions and biometric authentication.

### BRIEF DESCRIPTION OF THE DRAWINGS

The objects and advantages of the invention may be apparent upon consideration of the following detailed description, taken in conjunction with the accompanying drawings, in which like reference characters refer to like parts throughout, and in which:

FIG. 1 shows an illustrative diagram in accordance with principles of the disclosure;

FIG. 2A shows an illustrative flow diagram in accordance with principles of the disclosure;

FIG. 2B shows a continuation of the illustrative flow diagram of FIG. 2A in accordance with principles of the disclosure;

FIG. 3 shows a schematic diagram in accordance with principles of the disclosure; and

FIG. 4 shows another schematic diagram in accordance with principles of the disclosure.

### DETAILED DESCRIPTION OF THE DISCLOSURE

Systems and methods according to the current disclosure use silent push notifications to enable flagged transactions. Such systems and methods may increase client confidence, security, and ease of transactions.

In some embodiments, the systems and methods may involve delivering an MDA a silent push notification prior to enabling a flagged transaction.

In some embodiments, use cases may apply to applications of client authentication involving non-digital mechanisms for authentication. For example, when a client initiates a transaction by making an inbound call to an entity, or a specific number within an entity, the entity may send a silent push alert notification to a trusted user device to extract user active profile data including user location data. Other non-digital authentication attempts may include ATM withdrawals, in person attempts, by telephone, and by mail.

Silent push notifications may have several limitations that the systems and methods may address. First, delivery of silent push notifications is not guaranteed. Silent push notifications may be delivered on a best-effort basis. Factors such as poor network connectivity, device offline status, and access point names (“APNs”) server conditions may delay or prevent silent push notification delivery.

Second, silent push notifications may provide limited background execution time. Operating systems limit the amount of time an MDA may run in the background after receiving a silent push notification. Therefore, tasks (and transactions) must be completed quickly, typically within a few seconds. Otherwise, the MDA may be terminated.

Third, silent push notifications may have background mode requirements. To handle silent push notifications, the MDA must have a “Remote Notifications” background mode enabled. Without this enabled, the MDA cannot execute tasks in response to silent push notifications.

Fourth, silent push notifications may require user permissions. Users generally must grant an MDA explicit permission to access location data. If users disable location services or background app refresh, the MDA may not be able to retrieve location data in response to a silent push notification.

Fifth, silent push notifications may be rate limiting and throttling. MDAs usually have rate limits and throttles for push notifications to prevent abuse. Excessive silent push notifications can be delayed or suppressed, impacting the MDA's ability to perform timely background updates.

And sixth, silent push notifications may not provide user notifications. Silent push notifications do not alert the user directly. They are therefore unsuitable for actions requiring immediate user attention and may be used for background updates only.

The systems and methods may address the above issues using the following security and privacy considerations.

First, user consent may be obtained. In some embodiments, the systems and methods may ensure users provide explicit consent for location sharing.

Second, data security may be bolstered. In some embodiments, the systems and methods may use secure communication protocols (e.g., HTTPS) to transmit location data.

Third, the systems and methods may minimize data retention. In some embodiments, the systems and methods may store location data only as long as necessary for transaction validation.

And fourth, transparency may be accomplished. The systems and methods may inform users about how their location data may be used for security purposes.

Systems operable to enable a flagged transaction using a silent push notification are provided. The systems may include a computing processor. The computing processor may be configured to send silent push notifications to enable flagged transactions.

The systems may include a trusted user device. The trusted user device may be preprogrammed as a trusted user device. The trusted user device may be tagged as a trusted user device.

The systems may include a server cloud. The server cloud may be in bidirectional communication with the trusted user device. The server cloud may be in bidirectional communication with the computing processor. The computing processor may be in bidirectional communication with the trusted user device via the central server.

The systems may be configured to receive, by the computing processor, a request for the transaction. The systems may be configured to analyze, by the computing processor, the transaction to determine a security level.

The systems may be configured to generate, by a machine learning model (“MLM”) on the computing processor, a first security score for the transaction. The first security score may be based on the security level. The systems may be configured to flag, by the computing processor, the transaction when the first security score is below a threshold security score. For example, a security score may be a score ranging from 0 to 100, where 100 is a maximum security score and 0 is a minimum security score. The threshold security score may be, for example, 80, 90, or 95.

The systems may be configured to send, by the computing processor via the server cloud, a silent push notification to the trusted user device. The silent push notification may include a notification payload. The notification payload may include security data from the flagged transaction.

The systems may be configured to receive, by an MDA on the trusted user device, the silent push notification with the notification payload. The notification payload may include a content-available key. The content-available key may ensure the MDA initializes from a dormant state when the content-available key is activated.

The systems may be configured to check, by the MDA, that location permissions are activated on the MDA. The systems may be configured to verify, by the MDA, that a background MDA refresh is enabled.

The systems may be configured to retrieve, by the MDA, user active profile data from location services on the trusted user device. The user active profile data may include current location coordinates of the trusted user device. The current location coordinates may include latitude and longitude coordinates.

The systems may be configured to compare, by the computing processor, the user active profile data with a plurality of trusted locations. The plurality of trusted locations may be determined by AI.

AI may determine the plurality of trusted locations. AI may determine the plurality of trusted locations, for example, by comparing the user active profile data and the security data to verified trusted locations from an external database. In response to determining that the user active profile data or the security data include at least one of the verified trusted locations, the AI may determine that the verified trusted locations included within the user active profile data, or the security data are the plurality of trusted locations.

The systems may be configured to generate, by the MLM on the computing processor, a second security score based on a comparison of the user active profile data with the security data.

The systems may be configured to, in response to determining that the user active profile data matches at least one of the plurality of trusted locations, and the second security score is above the threshold security score, enable the flagged transaction to proceed by the computing processor.

The systems may be configured to, in response to determining that the user active profile data does not match at least one of the plurality of trusted locations, or the second security score is below the threshold security score, initiate additional verification steps by the computing processor. The additional verification steps may include, for example, additional authentication questions and biometric authentication.

The systems may be configured to, in response to determining that the additional verification steps passed, enable the flagged transaction to proceed by the computing processor.

The systems may be configured to, in response to determining that the additional verification steps failed, deny the flagged transaction to proceed by the computing processor. The systems may be configured to notify the trusted user device, by the MDA, whether the flagged transaction was enabled or denied by the computing processor.

The systems may be configured to flag, by the computing processor, the transaction when the transaction includes a large transaction amount. The systems may be configured to flag, by the computing processor, the transaction when the transaction includes a transaction to a new account. The systems may be configured to flag, by the computing processor, the transaction when the transaction includes a transaction to a suspicious account. The systems may be configured to flag, by the computing processor, the transaction when the transaction includes an unusual transaction pattern.

The plurality of trusted locations may include areas extending about 10, 20, 30, 40, 50, 100, 200, 500, and 1000 feet from borders of trusted entities. The transaction may include a non-digital authentication attempt. The non-digital authentication attempt may be made without a digital device.

The additional verification steps may also include contacting the trusted user device. The additional verification steps may include asking user identification (“ID”) questions. The additional verification steps may include requesting a personal identification number (“PIN”).

The plurality of trusted locations may include financial center locations. The plurality of trusted locations may include entity locations. The plurality of trusted locations may include user work addresses. The plurality of trusted locations may include user home addresses.

The systems may be configured to identify whether the trusted user device was reported stolen. The systems may be configured to, in response to determining that the trusted user device was reported stolen, deactivate the trusted user device.

The user active profile data may include geolocation data. The user active profile data may include an IP address. The user active profile data may include active call data. The user active profile data may include a mobile-bound phone number.

The systems may be configured to identify whether the IP address conforms to a known IP address for the trusted user device. The systems may be configured to, in response to determining the IP address does not conform to the known IP address for the trusted user device, deactivate the trusted user device.

The systems may be configured to identify whether the geolocation data conforms to a known geolocation for the trusted user device. The systems may be configured to, in response to determining the geolocation data does not conform to the known geolocation for the trusted user device, deactivate the trusted user device.

Methods for utilizing silent push notifications enabling flagged transactions are provided. The methods may include receiving, by the computing processor, a request for the transaction.

The methods may include analyzing, by the computing processor, the transaction to determine a security level. The methods may include generating, by an MLM on the computing processor, a first security score for the transaction. The first security score may be based on the security level. The methods may include flagging, by the computing processor, the transaction when the first security score is below a threshold security score.

The methods may include sending, by the computing processor via the server cloud, a silent push notification to the trusted user device. The silent push notification may include a notification payload. The notification payload may include security data from the flagged transaction.

The methods may include receiving, by an MDA on the trusted user device, the silent push notification with the notification payload. The notification payload may include a content-available key. The content-available key may ensure the MDA initializes from a dormant state when the content-available key is activated.

The methods may include checking, by the MDA, that location permissions are activated on the MDA. The methods may include verifying, by the MDA, that a background MDA refresh is enabled.

The methods may include retrieving, by the MDA, user active profile data from location services on the trusted user device. The user active profile data may include current location coordinates of the trusted user device. The current location coordinates may include latitude and longitude coordinates.

The methods may include comparing, by the computing processor, the user active profile data with a plurality of trusted locations. The plurality of trusted locations may be determined by AI.

The methods may include generating, by the MLM on the computing processor, a second security score based on a comparison of the user active profile data with the security data.

The methods may include, in response to determining that the user active profile data matches at least one of the plurality of trusted locations, and the second security score is above the threshold security score, enabling the flagged transaction to proceed by the computing processor.

The methods may include, in response to determining that the user active profile data does not match at least one of the plurality of trusted locations, or the second security score is below the threshold security score, initiating additional verification steps by the computing processor. The methods may include, in response to determining that the additional verification steps passed, enabling the flagged transaction to proceed by the computing processor.

The methods may include, in response to determining that the additional verification steps failed, denying the flagged transaction to proceed by the computing processor. The methods may include notifying the trusted user device, by the MDA, whether the flagged transaction was enabled or denied by the computing processor.

The methods may include flagging, by the computing processor, the transaction when the transaction includes a large transaction amount. The methods may include flagging, by the computing processor, the transaction when the transaction includes a transaction to a new account. The methods may include flagging, by the computing processor, the transaction when the transaction includes a transaction to a suspicious account. The methods may include flagging, by the computing processor, the transaction when the transaction includes an unusual transaction pattern.

The methods may include identifying a plurality of trusted locations including areas extending about 10, 20, 30, 40, 50, 100, 200, 500, and 1000 feet from borders of trusted entities. The methods may include flagging a transaction including a non-digital authentication attempt. The non-digital authentication attempt may be made without a digital device.

The methods may include additional verification steps. The additional verification steps may include contacting the trusted user device. The additional verification steps may include asking user ID questions. The additional verification steps may include requesting a PIN.

The methods may include identifying a plurality of trusted locations including financial center locations. The methods may include identifying a plurality of trusted locations entity locations. The methods may include identifying a plurality of trusted locations user work addresses. The methods may include identifying a plurality of trusted locations user home addresses.

The methods may include identifying whether the trusted user device was reported stolen. The methods may include, in response to determining that the trusted user device was reported stolen, deactivating the trusted user device.

The methods may include extracting user active profile data. The user active profile data may include, for example, geolocation data. The user active profile data may include an IP address. The user active profile data may include active call data. The user active profile data may include a mobile-bound phone number.

The methods may include identifying whether the IP address conforms to a known IP address for the trusted user device. The methods may include, in response to determining the IP address does not conform to the known IP address for the trusted user device, deactivating the trusted user device.

The methods may include identifying whether the geolocation data conforms to a known geolocation for the trusted user device. The methods may include, in response to determining the geolocation data does not conform to the known geolocation for the trusted user device, deactivating the trusted user device.

Advantages of the current embodiments may include potentially decreasing losses attributable to security breaches and reductions in inbound and/or outbound call volumes.

High client confidence results, achieved through the embodiments set forth herein, can obtain high-quality relationships and responsible growth.

Furthermore, such embodiments can help an entity emerge as a leader, instilling client confidence. Such client confidence can affect how clients transact with entities.

Systems and methods described herein are illustrative. Systems and methods in accordance with this disclosure may now be described in connection with the figures, which form a part hereof. The figures show illustrative features of system and method steps in accordance with the principles of this disclosure. It is to be understood that other embodiments may be utilized, and that structural, functional and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods.

Illustrative method steps may be combined. For example, an illustrative method may include steps shown in connection with another illustrative method.

Systems may omit features shown or described in connection with illustrative systems. Embodiments may include features that are neither shown nor described in connection with the illustrative systems. Features of illustrative systems may be combined. For example, an illustrative embodiment may include features shown in connection with another illustrative embodiment.

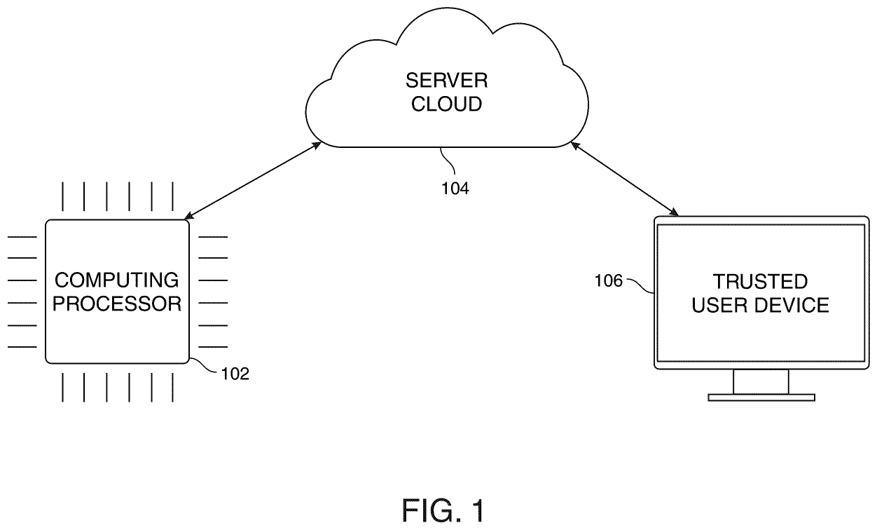

FIG. 1 shows an illustrative diagram. A computing processor is shown at 102. Computing processor 102 may be an AI system.

A server cloud is shown at 104. The server cloud 104 may communicate bidirectionally with the computing processor 102.

A trusted user device is shown at 106. The server cloud 104 may communicate bidirectionally with the trusted user device 106.

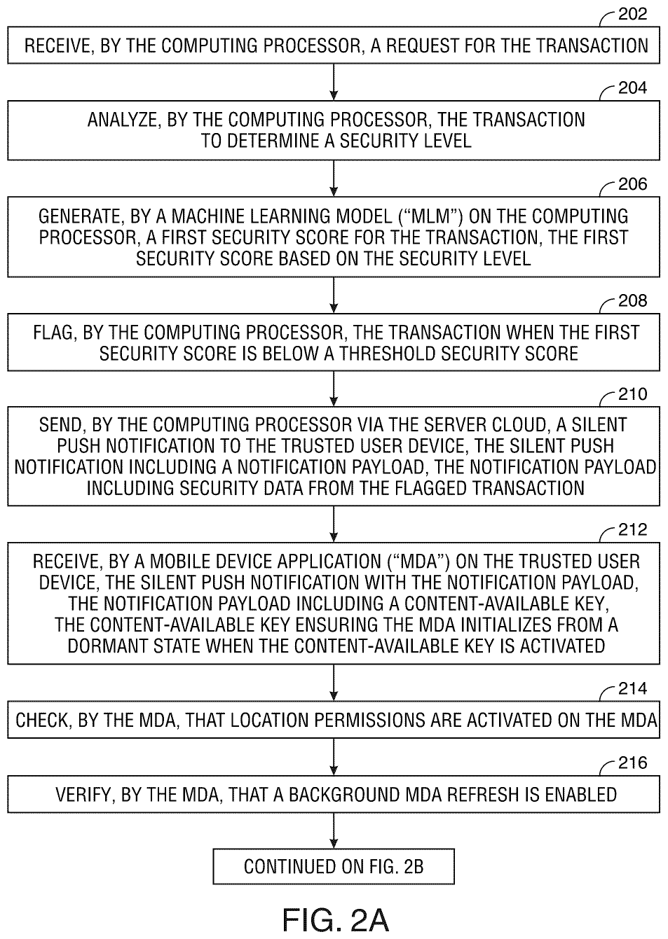

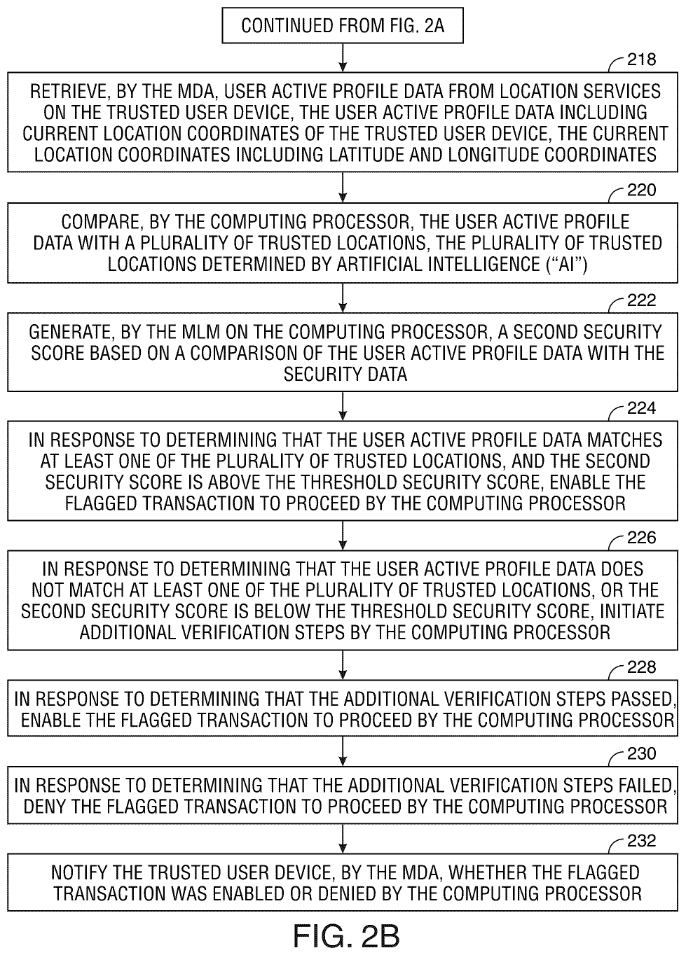

FIG. 2A shows an illustrative flow diagram. The illustrative flow diagram represents an embodied method of enabling flagged transactions via silent push client notifications.

First, at step 202, a computer processor may receive a request for the transaction. Next, at step 204, the computing processor may analyze the transaction to determine a security level.

Then, at step 206, an MLM may generate a first security score for the transaction. The first security score may be based on the security level. The MLM may be located on the computing processor.

At step 208, the computing processor may flag the transaction when the first security score is below a threshold security score.

At step 210, the computing processor may send, via the server cloud, a silent push notification to the trusted user device. The silent push notification may include a notification payload. The notification payload may include security data from the flagged transaction.

At step 212, an MDA on the trusted user device may receive the silent push notification with the notification payload. The notification payload may include a content- available key. The content-available key may ensure the MDA initializes from a dormant state when the content-available key is activated.

It is important that the MDA initializes from a dormant state when the content-available key is activated. The content-available key may be a code that registers with the MDA. The content-available key may ensure that there is content available to be extracted from the MDA.

Further, initializing from a dormant state when the content-available key is activated may be important for optimizing resource management and enhancing user experience in MDAs. This feature at step 212 may minimize unnecessary resource consumption by ensuring that the MDA is only activated when needed, thereby conserving battery life and system performance.

This feature at step 212 also may ensure that users receive timely updates and fresh content as soon as they open the MDA. This may contribute to a more responsive and seamless interaction.

Additionally, initializing from a dormant state may help manage background tasks more efficiently. For example, this feature may prevent the MDA from overloading the system and may maintain overall stability. And for MDAs that synchronize data with servers or cloud services, this feature may ensure that data is up-to-date and consistent across devices.

Next, at step 214, the MDA may check that location permissions are activated on the MDA. At step 216, the MDA may verify that a background MDA refresh is enabled.

It is important that background MDA refresh is enabled. Enabling background MDA refresh is critical for maintaining functionality and efficiency of MDAs. This feature at step 216 may enable MDAs to update their content and extract new information even when they are not actively in use. This may ensure that users receive the latest data and updates as soon as they open the MDA.

Further, enabling background MDA refresh may enhance user experience by providing timely notifications and preloading content, thereby reducing wait times and improving device responsiveness. Additionally, background MDA refresh may improve data synchronization with cloud services, keeping information consistent across multiple devices.

Background MDA refresh may also help optimize performance by performing updates and maintenance tasks during times that minimize impact on device performance and battery life. For MDAs that rely on location services, background refresh may enable continuous tracking and updating of location-based information. This feature may be vital for navigation and other location-dependent services.

FIG. 2B is a continuation of the illustrative flow diagram of FIG. 2A. FIGS. 2A and 2B together represent an embodied method of enabling flagged transactions via silent push client notifications.

At step 218, the MDA may retrieve user active profile data from location services on the trusted user device. The user active profile data may include current location coordinates of the trusted user device. The current location coordinates may include latitude and longitude coordinates.

At step 220, the computing processor may compare the user active profile data with a plurality of trusted locations. The plurality of trusted locations may be determined by AI.

At step 222, the MLM may generate a second security score based on a comparison of the user active profile data with the security data. The MLM may be located on the computing processor.

At step 224, the computing processor may enable the flagged transaction to proceed in response to determining that the user active profile data matches at least one of the plurality of trusted locations, and the second security score is above the threshold security score.

At step 226, the computing processor may initiate additional verification steps in response to determining that the user active profile data does not match at least one of the plurality of trusted locations, or the second security score is below the threshold security score.

At step 228, the computing processor may enable the flagged transaction to proceed in response to determining that the additional verification steps passed.

At step 230, the computing processor may deny the flagged transaction to proceed in response to determining that the additional verification steps failed.

And at step 232, the MDA may notify the trusted user device whether the flagged transaction was enabled or denied by the computing processor.

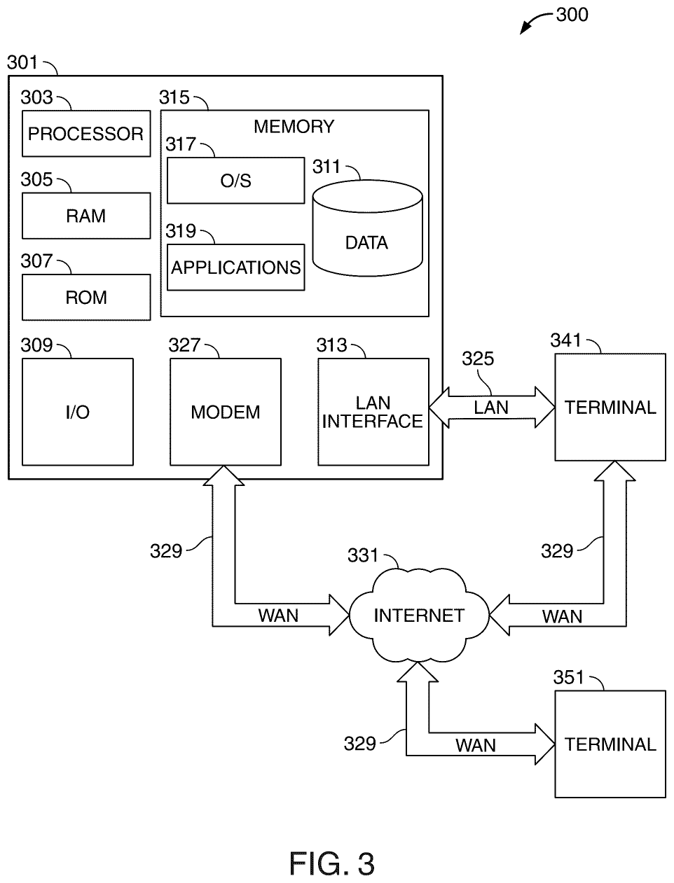

FIG. 3 shows an illustrative block diagram of apparatus 300 that includes computing device 301. Computing device 301 may alternatively be referred to herein as a “control circuit.” Elements of apparatus 300, including computing device 301, may be used to implement various aspects of the apparatus and methods disclosed herein. A “user” of apparatus 300 or a control circuit may include other computer apparatus or servers, such as an authentication server.

Computing device 301 may have a microprocessor 303 for controlling the operation of the device and its associated components, and may include RAM 305, ROM 307, input/output module 309, and a non-transitory memory 315. The microprocessor 303 may also execute all software running on the computing device 301—e.g., the operating apparatus. Other components commonly used for computers, such as EEPROM or Flash memory or any other suitable components, may also be part of the control circuit.

The memory 315 may be comprised of any suitable permanent storage technology—e.g., a hard drive or other non-transitory memory. The ROM 307 and RAM 305 may be included as all or part of memory 315. The memory 315 may store software including the operating system 317 and application(s) 319 along with any other data 311 needed for the operation of the apparatus 300. Memory 315 may also store videos, text, and/or audio assistance files. The videos, text, and/or audio assistance files may also be stored in cache memory, or any other suitable memory. Alternatively, some or all of computer executable instructions (alternatively referred to as “code”) may be embodied in hardware or firmware (not shown). The microprocessor 303 may execute the instructions embodied by the software and code to perform various functions.

The term “non-transitory memory,” as used in this disclosure, is a limitation of the medium itself, i.e., it is a tangible medium and not a signal, as opposed to a limitation on data storage types (e.g., RAM vs. ROM). “Non transitory memory” may include both RAM and ROM, as well as other types of memory.

In an embodiment of the computing device 301, the microprocessor 303 may execute the instructions in all or some of the operating system 317, any applications 319 in the memory 315, and any other code embodied in hardware or firmware (not shown).

An input/output (“I/O”) module 309 may include connectivity to a keypad, a touchscreen, a radar transmitter and receiver, or network interface through which higher hierarchal server or a user of apparatus 300 may provide input. The input may include input relating to cursor movement. The input/output module 309 may also include one or more speakers for providing audio output and a video display device, such as an LED screen and/or touchscreen, for providing textual, audio, audiovisual, and/or graphical output (not shown). The input and output may be related to results using and interacting with an ATM.

Apparatus 300 may be connected to other apparatus, computers, servers, and/or the internet via a local area network (LAN) interface 313.

Apparatus 300 may operate in a networked environment supporting connections to one or more remote computers and servers, such as terminals 341 and 351, including, in general, the internet and “cloud”. References to the “cloud” in this disclosure generally refer to the internet. “Cloud-based applications” generally refer to applications located on a server remote from a user, wherein some or all of the application data, logic, and instructions are located on the internet and are not located on a user's local device. Cloud-based applications may be accessed via any type of internet connection (e.g., cellular or wi-fi).

Terminals 341 and 351 may be personal computers or servers that include many or all of the elements described above relative to apparatus 300. The network connections depicted in FIG. 3 include a local area network (LAN) 325 and a wide area network (WAN) 329 but may also include other networks, such as a cellular network. Computing device 301 may include a network controller interface (not shown), which may include a modem 327 and LAN interface or adapter 313, as well as other components and adapters (not shown). When used in a LAN networking environment, computing device 301 is connected to LAN 325 through a LAN interface or adapter 313. When used in a WAN networking environment, computing device 301 may include a modem 327 or other means for establishing communications over WAN 329, such as Internet 331. The modem 327 and/or LAN interface 313 may connect to a network via an antenna (not shown). The antenna may be configured to operate over Bluetooth, Wi-Fi, cellular networks (including 5G), or other suitable frequencies.

It will be appreciated that the network connections shown are illustrative and other means of establishing a communications link between computers may be used. The existence of various well-known protocols such as TCP/IP, Ethernet, FTP, HTTP and the like is presumed, and the apparatus can be operated in a client-server configuration to permit a user to retrieve web pages from a web-based server. The web-based server may transmit data to any other suitable computer apparatus. The web-based server may also send computer-readable instructions, together with the data, to any suitable computer apparatus. The computer-readable instructions may be to store the data in cache memory, the hard drive, secondary memory, or any other suitable memory.

Application program(s) 319 (which may be alternatively referred to herein as “plugins,” “applications,” or “apps”) may include computer executable instructions for invoking user functionality related to performing various tasks such as interacting with an ATM. In an embodiment, application program(s) 319 may be cloud-based applications. The various tasks may be related to authenticating a user and processing one or more ATM transactions.

Computing device 301 may also include various other components, such as a battery (not shown), power supply (not shown), radar components (not shown), screen (not shown), speaker (not shown), network controller interface (not shown), and/or antennas (not shown).

Terminal 351 and/or terminal 341 may be portable devices such as a laptop, cell phone, Blackberry™, tablet, smartphone, or any other suitable device for receiving, storing, transmitting and/or displaying relevant information. Terminals 351 and/or terminal 341 may be other devices such as remote servers, including authentication and transaction servers. Terminals 351 and/or 341 may be computers where a user is interacting with an application.

Any information described above in connection with data 311, and any other suitable information, may be stored in memory 315. One or more of applications 319 may include one or more algorithms that may be used to implement features of the disclosure, and/or any other suitable tasks.

The invention may be operational with numerous other general purpose or special purpose computing apparatus environments or configurations. Examples of well-known computing systems, environments, and/or configurations that may be suitable for use with the invention include, but are not limited to, personal computers, server computers, handheld or laptop devices, tablets, mobile phones, smart phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like. Secure systems and servers may be preferable.

Aspects of the invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network, e.g., cloud-based applications or remote authentication protocols. In a distributed computing environment, program modules may be located in both local and remote computer storage media including memory storage devices.

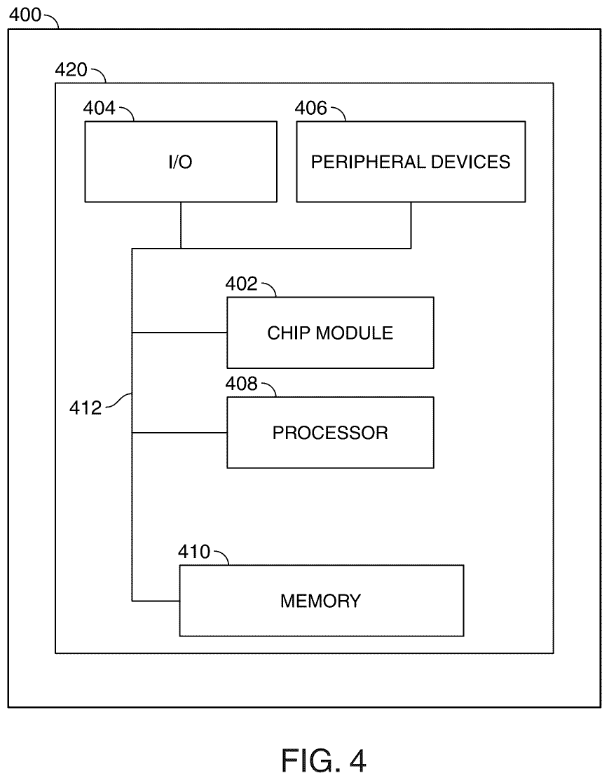

FIG. 4 shows illustrative apparatus 400 that may be configured in accordance with the principles of the disclosure. Apparatus 400 may be a server or computer various peripheral devices 406. Apparatus 400 may include one or more features of the apparatus shown in FIGS. 1-3. Apparatus 400 may include circuit board 420 and chip module 402, which may include one or more integrated circuits, and which may include logic configured to perform any other suitable logical operations.

Apparatus 400 and/or circuit board 420 may include one or more of the following components: I/O circuitry 404, which may include a transmitter device and a receiver device and may interface with fiber optic cable, coaxial cable, telephone lines, wireless devices, PHY layer hardware, a keypad/display control device, an LED screen, a touchscreen, a radar transmitter and receiver, or any other suitable media or devices; peripheral devices 406, which may include batteries and chargers, counter timers, real-time timers, power-on reset generators or any other suitable peripheral devices; logical processing device 408, which may compute data structural information and structural parameters of the data; and machine-readable memory 410.

Machine-readable memory 410 may be configured to store in machine-readable data structures: machine executable instructions (which may be alternatively referred to herein as “computer instructions” or “computer code”), applications, signals, encryption algorithm(s), recorded data, and/or any other suitable information or data structures.

Components 402, 404, 406, 408 and 410 may be coupled together by a system bus or other interconnections 412 and may be present on one or more circuit boards such as 420. In some embodiments, the components may be integrated into a single chip. The chip may be silicon-based.

Thus, systems and methods for enabling flagged transactions via silent push client notifications are provided. Persons skilled in the art may appreciate that the present invention can be practiced by other than the described embodiments, which are presented for purposes of illustration rather than of limitation. The present invention is limited only by the claims that follow.

What is claimed is:

1. A system operable to enable a flagged transaction using a silent push notification, the system comprising:
a computing processor;
a trusted user device; and
a server cloud;
wherein the system is configured to:
receive, by the computing processor, a request for the transaction;
analyze, by the computing processor, the transaction to determine a security level;
generate, by a machine learning model (“MLM”) on the computing processor, a first security score for the transaction, the first security score based on the security level;
flag, by the computing processor, the transaction when the first security score is below a threshold security score;
send, by the computing processor via the server cloud, a silent push notification to the trusted user device, the silent push notification including a notification payload, the notification payload including security data from the flagged transaction;
receive, by a mobile device application (“MDA”) on the trusted user device, the silent push notification with the notification payload, the notification payload including a content-available key, the content-available key ensuring the MDA initializes from a dormant state when the content-available key is activated;
check, by the MDA, that location permissions are activated on the MDA;
verify, by the MDA, that a background MDA refresh is enabled;
retrieve, by the MDA, user active profile data from location services on the trusted user device, the user active profile data including current location coordinates of the trusted user device, the current location coordinates including latitude and longitude coordinates;
compare, by the computing processor, the user active profile data with a plurality of trusted locations, the plurality of trusted locations determined by artificial intelligence (“AI”);
generate, by the MLM on the computing processor, a second security score based on a comparison of the user active profile data with the security data;
in response to determining that the user active profile data matches at least one of the plurality of trusted locations, and the second security score is above the threshold security score, enable the flagged transaction to proceed by the computing processor;
in response to determining that the user active profile data does not match at least one of the plurality of trusted locations, or the second security score is below the threshold security score, initiate additional verification steps by the computing processor;
in response to determining that the additional verification steps passed, enable the flagged transaction to proceed by the computing processor;
in response to determining that the additional verification steps failed, deny the flagged transaction to proceed by the computing processor; and
notify the trusted user device, by the MDA, whether the flagged transaction was enabled or denied by the computing processor.

2. The system of claim 1, wherein the system is further configured to flag, by the computing processor, the transaction when the transaction comprises at least one of a large transaction amount, a transaction to a new account, a transaction to a suspicious account, and an unusual transaction pattern.

3. The system of claim 1, wherein the plurality of trusted locations includes areas extending about 50 feet from borders of trusted entities.

4. The system of claim 1, wherein the transaction comprises a non-digital authentication attempt, the non-digital authentication attempt being made without a digital device.

5. The system of claim 1, wherein the additional verification steps include contacting the trusted user device, asking user identification (“ID”) questions, and requesting a personal identification number (“PIN”).

6. The system of claim 1, wherein the plurality of trusted locations includes financial center locations, entity locations, user work addresses, and user home addresses.

7. The system of claim 1, wherein the system is further configured to:
identify whether the trusted user device was reported stolen; and
in response to determining that the trusted user device was reported stolen, deactivate the trusted user device.

8. The system of claim 1, wherein the user active profile data includes geolocation data, an IP address, active call data, and a mobile-bound phone number.

9. The system of claim 8, wherein the system is further configured to:
identify whether the IP address conforms to a known IP address for the trusted user device; and
in response to determining the IP address does not conform to the known IP address for the trusted user device, deactivate the trusted user device.

10. The system of claim 8, wherein the system is further configured to:
identify whether the geolocation data conforms to a known geolocation for the trusted user device; and
in response to determining the geolocation data does not conform to the known geolocation for the trusted user device, deactivate the trusted user device.

11. A method for enabling a flagged transaction using a silent push notification, the method comprising:
receiving, by the computing processor, a request for the transaction;
analyzing, by the computing processor, the transaction to determine a security level;
generating, by a machine learning model (“MLM”) on the computing processor, a first security score for the transaction, the first security score based on the security level;
flagging, by the computing processor, the transaction when the first security score is below a threshold security score;
sending, by the computing processor via the server cloud, a silent push notification to the trusted user device, the silent push notification including a notification payload, the notification payload including security data from the flagged transaction;
receiving, by a mobile device application (“MDA”) on the trusted user device, the silent push notification with the notification payload, the notification payload including a content-available key, the content-available key ensuring the MDA initializes from a dormant state when the content-available key is activated;
checking, by the MDA, that location permissions are activated on the MDA;
verifying, by the MDA, that a background MDA refresh is enabled;
retrieving, by the MDA, user active profile data from location services on the trusted user device, the user active profile data including current location coordinates of the trusted user device, the current location coordinates including latitude and longitude coordinates;
comparing, by the computing processor, the user active profile data with a plurality of trusted locations, the plurality of trusted locations determined by artificial intelligence (“AI”);
generating, by the MLM on the computing processor, a second security score based on a comparison of the user active profile data with the security data;
in response to determining that the user active profile data matches at least one of the plurality of trusted locations, and the second security score is above the threshold security score, enabling the flagged transaction to proceed by the computing processor;
in response to determining that the user active profile data does not match at least one of the plurality of trusted locations, or the second security score is below the threshold security score, initiating additional verification steps by the computing processor;
in response to determining that the additional verification steps passed, enabling the flagged transaction to proceed by the computing processor;
in response to determining that the additional verification steps failed, denying the flagged transaction to proceed by the computing processor; and
notifying the trusted user device, by the MDA, whether the flagged transaction was enabled or denied by the computing processor.

12. The method of claim 11, wherein the method further comprises flagging, by the computing processor, the transaction when the transaction comprises at least one of a large transaction amount, a transaction to a new account, a transaction to a suspicious account, and an unusual transaction pattern.

13. The method of claim 11, wherein the plurality of trusted locations includes areas extending about 50 feet from borders of trusted entities.

14. The method of claim 11, wherein the transaction comprises a non-digital authentication attempt, wherein the non-digital authentication attempt is made without a digital device.

15. The method of claim 11, wherein the additional verification steps include contacting the trusted user device, asking user identification (“ID”) questions, and requesting a personal identification number (“PIN”).

16. The method of claim 11, wherein the plurality of trusted locations includes financial center locations, entity locations, user work addresses, and user home addresses.

17. The method of claim 11, wherein the method further comprises:
identifying whether the trusted user device was reported stolen; and
in response to determining that the trusted user device was reported stolen, deactivating the trusted user device.

18. The method of claim 11, wherein the user active profile data includes geolocation data, an IP address, active call data, and a mobile-bound phone number.

19. The method of claim 18, wherein the method further comprises:
identifying whether the IP address conforms to a known IP address for the trusted user device; and
in response to determining the IP address does not conform to the known IP address for the trusted user device, deactivating the trusted user device.

20. The method of claim 18, wherein the method further comprises:
identifying whether the geolocation data conforms to a known geolocation for the trusted user device; and
in response to determining the geolocation data does not conform to the known geolocation for the trusted user device, deactivating the trusted user device.
